(19) United States
(12) Patent Application Publication
(10) Pub. No.: US 2006/0109399 A1
(43) Pub. Date: May 25, 2006

(54) Reflecting polarizer and color liquid crystal display apparatus

(76) Inventors: Shigeo Kubota, Kanagawa (JP); Junichi Ohsako, Tokyo (JP); Toshitaka Kawashima, Kanagawa (JP); Hiroyuki Okita, Hiroshima (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/272,643

(22) Filed: Nov. 15, 2005

(30) Foreign Application Priority Data
Nov. 19, 2004 (JP) P2004-336375

(51) Int. Cl. G02F 1/1335

(52) U.S. Cl. 349/96

(57) ABSTRACT

The present invention has been made to form a reflecting polarizer without using a high-birefringence polymer. The present invention provides a reflecting polarizer that transmits a first linear polarization component that oscillates parallel to a first polarization plane of an incident light and reflects a second linear polarization component that oscillates parallel to a second polarization plane perpendicular to the first polarization plane by utilizing birefringence characteristics to polarize/split the incident light, comprising a dielectric multilayer film obtained by stacking, a plurality of times in an alternate manner, a high refractive index layer formed using a dielectric material having birefringence characteristics, and a low refractive index layer formed using a dielectric material having a refractive index which is substantially the same as one of the refractive indexes that the dielectric material having birefringence characteristics has.

### CROSS REFERENCES TO RELATED APPLICATIONS

The present invention contains subject matter related to Japanese Patent Application JP 2004-336375 filed in Japanese Patent Office on Nov. 19, 2004, the entire contents of which being incorporated herein by reference.

### BACKGROUND OF THE INVENTION

1. Field of the Invention

The present invention relates to a polarizer which is an optical element that transmits only linearly polarized light oscillating in one direction and, more particularly, to a reflecting polarizer for use in a liquid crystal display apparatus and a color liquid crystal display apparatus provided with the reflecting polarizer.

2. Description of the Related Art

In place of a CRT (Cathode ray Tube) type TV receiver that has been in use for many years since TV broadcasting began, an ultra-slim TV receiver such as a LCD (Liquid Crystal Display) or PDP (Plasma Display Panel) has been developed and already been put to practical use. In particular, a color liquid crystal display apparatus using a color liquid crystal display panel is expected to become increasingly popular thanks to its low power consumption or price-reduction of a large-sized color liquid crystal display panel and thereby the color liquid crystal display apparatus is regarded as a display apparatus having potential for further growth in the future.

The color liquid crystal display apparatus illuminates an image formed on a color liquid crystal display panel With an illumination light from a backlight unit to thereby display the image on the apparatus. FIGS. 1A and 1B are views each schematically explaining the principle of a TN (Twisted Nematic) type liquid crystal display panel. As shown in FIG. 1A, molecules-of liquid crystal LC encapsulated between two light distribution films af1 and af2 whose light distribution directions perpendicularly cross each other are arranged in a twisted manner. When a predetermined voltage is applied to liquid crystal LC at this time, the arrangement direction of the molecules of liquid crystal LC is switched to the vertical direction as shown in FIG. 1B.

Therefore, when polarization filters pf1 and pf2 whose polarization directions are made corresponding to the light distribution directions of the light distribution films af1 and af2 respectively are provided and a voltage is not applied to liquid crystal LC, a light that has been passed through the polarization filter pf1 travels while being twisted at right angles along spaces between the molecules of liquid crystal LC, as shown in FIG. 1A. Thus, in this case, the light can be passed through the polarization filter pf2.

On the other hand, when polarization filters pf1 and pf2 whose polarization directions are made corresponding to the light distribution directions of the light distribution films af1 and af2 respectively are provided and a voltage is applied to liquid crystal LC, a light that has been passed through the polarization filter pf1 travels along the molecules of liquid crystal LC without changing direction. Thus, in this case, the light cannot be passed through the polarization filter pf2.

As described above, liquid crystal LC uses a voltage as a trigger to serve as a shutter for transmitting or shielding a light. This is the principle of image display in the liquid crystal display panel. A control of the voltage to be applied to liquid crystal LC allows not only two values of black and white but also gray-scale to be expressed.

As described with reference to FIGS. 1A and 1B, a light allowed to enter liquid crystal LC needs to be a linearly polarized light that oscillates in one direction. For that purpose, the light is passed through the polarization filter pf1. Accordingly, the amount of the light that has been emitted by a liquid crystal backlight unit is reduced to half or less at the time when the light enters a liquid crystal display panel. That is, the existence of the polarization filter significantly reduces the brightness of the liquid crystal display apparatus. In order to ensure desired brightness in the liquid crystal display apparatus, it is necessary to increase the amount of the light to be emitted from the backlight unit in consideration of a light amount loss caused due to existence of the polarization filter, which accounts for an increase in power consumption.

To cope with this, a method in which, of the light entering from the backlight unit to liquid crystal display panel, a polarization component that is lost by the polarization filter is reused to increase the brightness of the liquid crystal display apparatus while power consumption is suppressed has been designed.

Specifically, it is possible to reuse the light amount corresponding to the loss caused due to existence of the polarization filter of the liquid crystal display panel by disposing a film called brightness enhancement film which is a reflecting polarizer between the-backlight unit and liquid crystal display panel. Hereinafter, using a liquid crystal display apparatus 100 of FIG. 2 including an edge-light type backlight unit 110 as a model, examination of an illumination light entering a liquid crystal display panel 120 will be made by comparing the cases where a brightness enhancement film 130 is used and where the film 130 is not used.

As shown in FIG. 2, the brightness enhancement film 130 is not used in the left side region LF of the liquid crystal display apparatus 100, so that a light emitted from a light source 111 is polarized in substantially the vertical direction while being guided by a light guiding plate 112 and directly enters a polarization filter afd on the lower side of the liquid crystal display panel 120 as an illumination light. The polarization filter afd on the lower side of the liquid crystal display panel 120 transmits only so-called a P-polarized light and shield a S-polarized light that crosses the P-polarized light at right angles.

Naturally, at this time, only the P-polarized light that has been passed through the lower side polarization filter afd and has been subjected to spatial modulation by the liquid crystal display panel 120 is output from the left side region LF of the liquid crystal display apparatus 100.

On the other hand, as shown in FIG. 2, the brightness enhancement film 130 is disposed between the backlight unit 110 and liquid crystal display panel 120 in the right side region RF of the liquid crystal display apparatus 100, so that an illumination light that has been emitted through the light source 111 and light guiding plate 112 as described above firstly enters the brightness enhancement film 130 and then enters the polarization filter afd on the lower side of the liquid crystal display panel 120. Like the lower side polarization filter afd, the brightness enhancement film 130 transmits the P-polarized light. The brightness enhancement film 130 does not transmit the S-polarized light but reflects it toward the backlight unit 110.

A part of the S-polarized light that has been reflected toward the backlight unit 110 is reflected by the surface of the light guiding plate 112 or enters the light guiding plate 112. The S-polarized light that enters the light guiding plate 112 is reflected by a reflection sheet 113 disposed on the bottom surface of the light guiding plate 112 so as to be converted into the P-polarized light and enters again the brightness enhancement film 130. The P-polarized light that has entered-the brightness enhancement film 130 is passed through the brightness enhancement film 130 and liquid crystal display panel 120 as an increase in light amount, so that it is possible to increase the brightness of the right side region RF of the liquid crystal display apparatus 100 more than that of the left side region LF.

The brightness enhancement film 130 that polarizes and splits the light emitted from the backlight unit 110 and realizes the reuse of the polarization component which was regarded as being unnecessary is adopted in many liquid crystal display apparatus used today and becomes a functional member indispensable for constituting the liquid crystal display apparatus. As a brightness enhancement film, DBEF™ (manufactured by Sumitomo 3M limited, Japan) is adopted in many liquid crystal display apparatus used today (refer to, for example, <URL: http://www.mmm.cojp/display/dbef/index.html>).

DBEF realizes a stacked structure including a combination of high refractive index materia/low refractive index material by using a high-birefringence polymer. DBEF therefore has a refractive index difference in a given direction within its surface and does not have a refractive index difference in the direction perpendicular to the given direction. DBEF having the above structure is a multilayer optical film that reflects a light (for example, S-polarization component) that oscillates in the direction that the refractive index difference exists and transmits a light (for example, P-polarization component) that oscillates in the direction that the refractive index difference does not exist.

### SUMMARY OF THE INVENTION

The present invention has been made in view of the above background art, and it is desirable to provide a reflecting polarizer capable of polarizing/splitting a light and reflecting/reusing the polarization component which was regarded as being unnecessary without using a high-birefringence polymer, and a color liquid crystal display apparatus provided with the reflecting polarizer.

According to the present invention, there is provided a reflecting polarizer that transmits a first linear polarization component that oscillates parallel to a first polarization plane of an incident light and reflects a second linear polarization component that oscillates parallel to a second polarization plane perpendicular to the first polarization plane by utilizing birefringence characteristics to polarize/split the incident light. The reflecting polarizer is a dielectric multilayer film obtained by stacking, a plurality of times in an alternate manner, a high refractive index layer formed using a dielectric material having birefringence characteristics; and a low refractive index layer formed using a dielectric material having a refractive index which is substantially the same as one of the refractive indexes that the dielectric material having birefringence characteristics has.

According to the present invention, there is provided a color liquid crystal display apparatus including: a transmissive type color liquid crystal display panel having a color filter including three primary color filters that selectively transmit the wavelengths of a red light, a green light, and a blue light; a backlight unit that illuminates the color liquid crystal display panel from the backside thereof with a white light; and a reflecting polarizer between the color liquid crystal display panel and backlight unit. The backlight unit has a light source constituted by a red LED that emits a red light having a peak wavelength of λpr, a green LED that emits a green light having a peak wavelength of λpg, and a blue LED that emits a blue light having a peak wavelength of λpb and a color mixing means for mixing the red, green, and blue lights emitted from the light source to create the white color. The reflecting polarizer is a dielectric multilayer film obtained by stacking, a plurality of times in an alternate manner, a high refractive index layer formed using a dielectric material having birefringence characteristics; and a low refractive index layer formed using a dielectric material having a refractive index which is substantially the same as one of the refractive indexes that the dielectric material having birefringence characteristics has. The reflecting polarizer transmits a first linear polarization component that oscillates parallel to a first polarization plane of a white light emitted from the backlight unit for respective red, green, and blue lights that constitute the white light and reflects a second linear polarization component that oscillates parallel to a second polarization plane thereof that is perpendicular to the first polarization plane by utilizing birefringence characteristics to polarize/split the incident white light.

A reflecting polarizer according to the present invention is a dielectric multilayer film obtained by stacking, a plurality of times in an alternate manner, a high refractive index layer formed using a dielectric material having birefringence characteristics; and a low refractive index layer formed using a dielectric material having a refractive index which is substantially the same as one of the refractive indexes that the dielectric material having birefringence characteristics has. The reflecting polarizer transmits a first linear polarization component that oscillates parallel to a first polarization plane of an incident light and reflects a second linear polarization component that oscillates parallel to a second polarization plane perpendicular to the first polarization plane by utilizing birefringence characteristics to polarize/split the incident light.

With the above configuration, when the present invention is used in the liquid crystal display apparatus, it is possible to polarize/split respective color lights emitted from the backlight unit as well as to reuse the reflected polarization components, thus preventing polarization components from being absorbed to become heat energy to suppress the loss. Accordingly, use efficiency of a light emitted from the backlight unit and illuminating the color liquid crystal display panel is increased to significantly enhance the brightness.

Further, in the present invention, since the reflecting polarizer is formed by a dielectric multilayer film, film design corresponding to the wavelength of a light source to be used as the backlight unit is easy to be made, thereby optimizing the reflectivity characteristics regardless of the type of a light source to be used.

### BRIEF DESCRIPTION OF THE DRAWINGS

FIGS. 1A and 1B are views for explaining the display principle of a liquid crystal display panel; FIG. 1A is a view showing a state where a light is passed through the liquid crystal display panel in the case where a voltage is not applied to a liquid crystal, and FIG. 1B is a view showing a state where a light is not passed through the liquid crystal display panel in the case where a voltage is applied to a liquid crystal;

FIG. 2 is a view for explaining a function of a brightness enhancement film;

FIG. 3 is a view for explaining a configuration of a color liquid crystal display apparatus according to a preferred embodiment of the present invention;

FIG. 4 is a view showing the spectrum characteristics of LEDs used as a light source of a backlight unit provided in the color liquid crystal display apparatus;

FIG. 5 is a view showing the spectrum characteristics of a three wavelength region light-emitting CCFL (Cold Cathod Fluorescent Lamp) widely used;

FIG. 6 is a view showing wavelength-reflectivity characteristics of a dielectric multilayer film corresponding to a green light in the case where calcium carbonate (CaCO₃) is used as a birefringence material;

FIG. 7 is a view showing wavelength-reflectivity characteristics of a dielectric multilayer film corresponding to three primary color lights in the case where CaCO₃ is used as a birefringence material;

FIG. 8 is a view showing wavelength-reflectivity characteristics of a light that oscillates parallel to the polarization plane having a small refractive index difference in a dielectric multilayer film using CaCO₃ as a birefringence material;

FIG. 9 is a view showing wavelength-reflectivity characteristics of a dielectric multilayer film corresponding to three primary color lights in the case where CaCO₃ is used as a birefringence material, wherein the LEDs having spectrum characteristics different from that of FIG. 4 are used as a light source;

FIG. 10 is a view showing wavelength-reflectivity characteristics of the dielectric multilayer film corresponding to blue and green lights in the case where Yittrium Vanadate (YVO₄) is used as a birefringence material;

FIG. 11 is a view showing wavelength-reflectivity characteristics of the dielectric multilayer film corresponding to three primary color lights in the case where YVO₄ is used as a birefringence material;

FIG. 12 is a view showing wavelength-reflectivity characteristics of the dielectric multilayer film corresponding to three primary color lights in the case where Barium Borate (α-BBO) is used as a birefringence material;

FIG. 13 is a view showing wavelength-reflectivity characteristics changed in accordance with the number of layers of the dielectric multilayer film corresponding to three primary color lights in the case where CaCO₃ is used as a birefringence material; and

FIG. 14 is a view showing dependency of the reflectivity of the dielectric multilayer film corresponding to three primary colors on the number of layers in the case where CaCO₃ is used as a birefringence material.

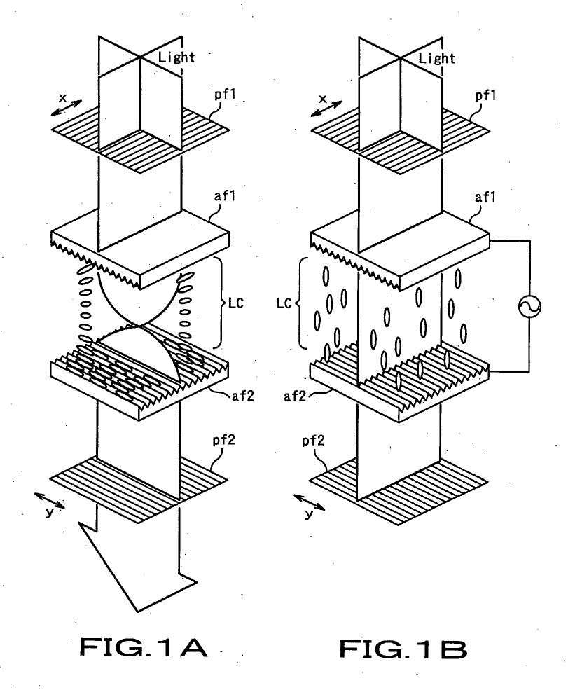

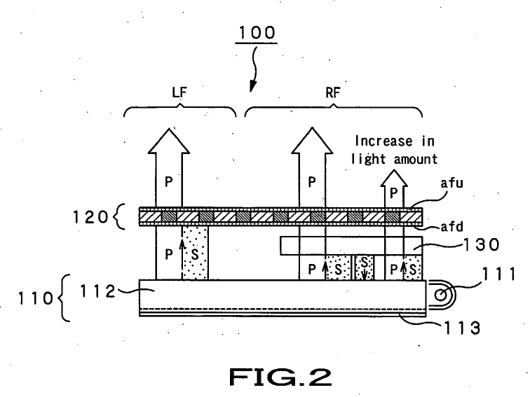

### DETAILED DESCRIPTION OF THE PREFERRED EMBODIMENTS

A preferred embodiment of the present invention will be described below with reference to the accompanying drawings. It goes without saying that the present invention is not limited to the following embodiments, and various changes may be made without departing from the scope of the invention.

In the present invention, a high-birefringence polymer used in the abovementioned DBEF is not used, but a dielectric multilayer film having birefringence characteristics is used to form a reflecting polarizer capable of polarizing/splitting a light and reflecting/reusing the polarization component.

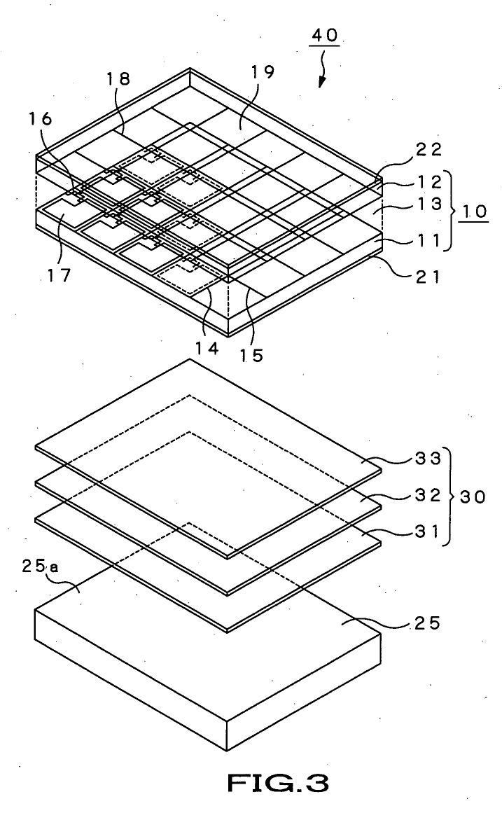

The present invention is applied, for example, a backlight type color liquid crystal display apparatus 40 having the configuration shown in FIG. 3.

The transmissive color liquid crystal display apparatus 40 includes a transmissive color liquid crystal display panel 10, a backlight unit 25 provided on the backside of the color liquid crystal display panel 10, and optical functional films 30 provided between the display panel 10 and the backlight unit 25.

Although not shown, the color liquid crystal display apparatus 40 may include a receiver that receives ground waves or satellite waves, such as an analog tuner or a digital tuner, a video signal processor and an audio signal processor that process a video signal and an audio signal received by the receiver, and an audio signal output section that outputs the audio signal processed by the audio signal processor, such as a speaker.

The transmissive color liquid crystal display panel 10 has a transparent 1PF1 glass substrate 11, an opposite electrode substrate 12, and a liquid crystal layer 13 in which twisted nematic (TN) liquid crystal is encapsulated. The TFT substrate 11 and opposite electrode substrate 12 are disposed opposite to each other. The liquid crystal layer 13 is provided between the TFT substrate 11 and opposite electrode substrate 12. Further, the color liquid crystal display panel 10 has polarization plates 21 and 22 interposing the TFT substrate 11 and opposite electrode substrate 12 therebetween.

Formed on the TFT substrate 11are a signal line 14 and scanning line 15 aligned in matrix form, a thin film transistor 16 disposed at the intersection of the signal line 14 and scanning line 15 and serving as a switching element, and a pixel electrode 17. The thin-film transistor 16 is selected by the scanning line 15 and writes a video signal supplied from the signal line 14 in the corresponding pixel electrode 17. Formed on the medial surface of the opposite electrode substrate 12 are an opposite electrode 18 and a color filter 19.

In the color liquid crystal display apparatus 40, the backlight unit 25 disposed on the backside of the transmissive color liquid crystal display panel 10 is used to irradiate the color liquid crystal display panel 10 having the above configuration with a white light. In this state, when the color liquid crystal display apparatus 40 is driven by an active matrix method, a desired full-color image can be displayed.

The backlight unit 25 has, although not shown, a red LED (light emitting diode) that emits a red light, a green LED that emits a green light, and a blue LED that emits a blue light as a light source. The backlight unit 25 emits, from a light emitting surface 25a thereof, a white light that has been obtained by mixing the respective lights from the light source to illuminate the color liquid crystal display panel 10.

Provided between the color liquid crystal display panel 10 and backlight unit 25 are the optical functional films 30 including a diffusion film 31, a prism film 32, a brightness enhancement film 33, and the like sequentially stacked on the light emitting surface 25a of the backlight unit 25. The configuration of the optical functional films 30 is not limited to the above, and any optical functional film can be used as long as it can convert the light emitted from the surface of the backlight unit 25 into an illumination light having the most suitable characteristics for illuminating the color liquid crystal display panel 10.

As described in the section of related art, the brightness enhancement film 33 of the optical functional films 30 polarizes/splits the light emitted from the backlight unit 25 and reflects/reuses the polarization component, which has been unnecessary by being polarized/split in the related art to thereby increase the brightness of the color liquid crystal display apparatus 40. In particular, since three LEDs that emit three primary color lights are used as a light source of the backlight unit 25, the brightness enhancement film 33 according to the embodiment of the present invention has an optical function corresponding to the light emission characteristics of the LEDs.

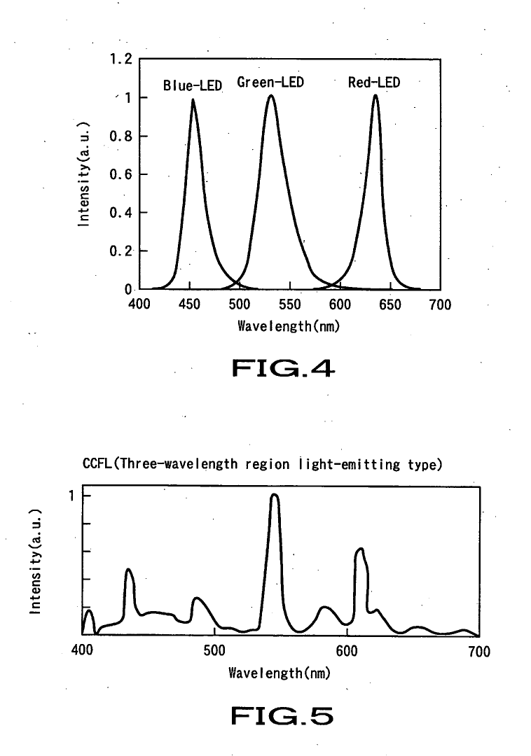

FIG. 4 shows the spectrum characteristics of a blue LED having a peak wavelength λpb of 455 nm, green LED having a peak wavelength λpg of 530 nm, and red LED having a peak wavelength λpr of 640 nm, which are used as a light source of the backlight unit 25. FIG. 5 shows the spectrum characteristics of a three wavelength region light-emitting CCFL (Cold Cathod Fluorescent Lamp) widely used as a light source of backlight units.

As shown in FIGS. 4 and 5, unlike the emission spectrum of the CCFL, each of the emission spectrums of the red LED, green LED, and blue LED does not have a plurality of sub-peaks across a broad region, but has an extremely narrow half-band width around its central wavelength. Therefore, by making the brightness enhancement film 33 corresponding to the spectrum characteristics of the LEDs shown in FIG. 4, the polarization component capable of being reflected/reused can be significantly increased.

[Brightness Enhancement Film 33 Using Dielectric Multilayer Film]

In the case of forming the brightness enhancement film 33 capable of polarizing/splitting a light and reflecting/reusing the polarization component in accordance with the spectrum characteristics of the LEDs that emit three primary color lights, a birefringence material is used to form a dielectric multilayer film in which a high refractive index layer and a low refractive index layer are alternately stacked.

The dielectric multilayer film in which a high refractive index layer and a low refractive index layer are alternately stacked strongly reflects a light having a given wavelength in a selective manner. Assuming that the given wavelength is λ, in order to strongly reflect the given wavelength λ in a selective manner, that is, in order to strongly reflect a light with the given wavelength λ as the center wavelength, the optical thicknesses of the high refractive index layer and low refractive index layer need to be set to λ/4, respectively.

Further, a dielectric material having birefringence characteristics is used as the high refractive index layer, and a dielectric material having a refractive index close to a lower refractive index of the dielectric material used as the high refractive index layer, that is, a dielectric material having a refractive index that reduces a refractive index difference is used as the low refractive index layer. As a result, the dielectric multilayer film formed by alternately stacking the high refractive index layer and low refractive index layer has a high reflectivity for the polarization component of a light that oscillates in the direction of the higher refractive index of the high refractive index layer, and has no reflectivity for the polarization component of a light that oscillates in the direction of the lower refractive index of the high refractive index layer, thereby exercising polarization split function.

The basic design principle for the brightness enhancement film 33 is as described above. The brightness enhancement film 33 thus designed can reflect or transmit a light having the given wavelength λ depending on the difference in the polarization component. Assuming that values of a peak wavelength λpr of red LED, a peak wavelength λpg of green LED, and peak wavelength λpb of blue LED are used as those of the given wavelengths, when three types of dielectric multilayer film sets, each of which includes in an alternately stacked manner the high refractive index layer and low refractive index layer having film thicknesses corresponding to one of the peak wavelengths of the three primary color lights, are stacked, it is possible to obtain the brightness enhancement film 33 capable of increasing the brightness of the backlight unit 25 using the LEDs that emit the three primary color lights as a light source.

### EXAMPLE 1

### Calcium Carbonate (CaCO₃) is Used as Dielectric Material Having Birefringence Characteristics

In Example 1, as the dielectric material having birefringence characteristics, CaCO₃ having refractive indexes of 1.48 and 1.66 corresponding to different polarization planes parallel to which a linearly-polarized light oscillates is used. That is, CaCO₃ is used to form the high refractive index layer of the brightness enhancement film 33 which is the dielectric multilayer film. As the low refractive index layer, on the other hand, SiO₂ which is a dielectric material having a refractive index of 1.455 which is close to the lower refractive index 1.48 of CaCO₃ is used.

The high refractive index layer and low refractive index layer are alternately stacked on a substrate such as PET (polyethylene terephthalate) by a known thin film formation method such as sputtering or vacuum evaporation to thereby form the brightness enhancement film 33.

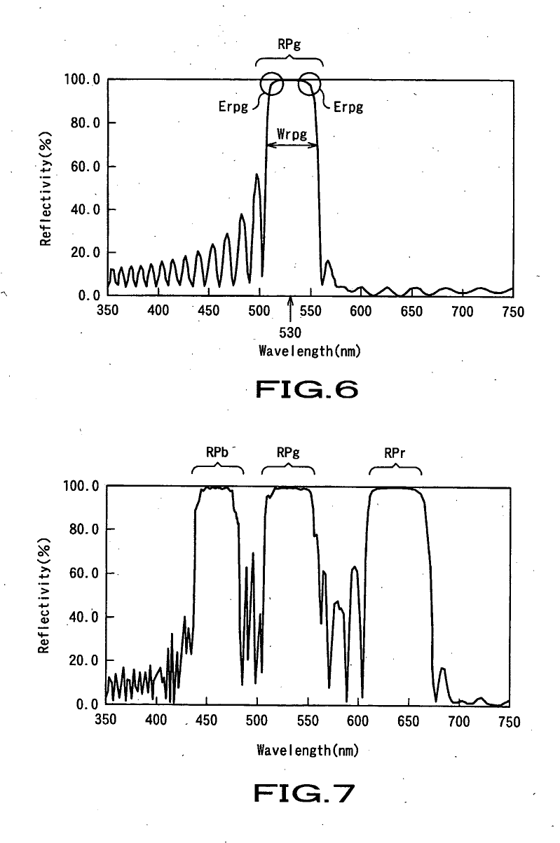

A description will be given about a dielectric multilayer film formed to correspond to a green light whose peak wavelength λpg is 530 mm in the case where the LEDs having the spectrum characteristics shown in FIG. 4 are used as a light source. Specifically, a combination of a high refractive index layer (0.5H) having an optical film thickness of 0.5 times the λpg/4, a low refractive index layer (1L) having an optical film thickness of λpg/4, and a high refractive index layer (0.5H) having an optical film thickness of 0.5 times the λpg/4 is set as a minimum stacking unit, and the minimum units are stacked 27 times ((0.5H1L0.5H)²⁷) to form a dielectric multilayer film. In this case, wavelength-reflectivity characteristics of the polarization component having a polarization plane in the direction that the refractive index of CaCO₃ is 1.66 becomes as shown in FIG. 6.

As shown in FIG. 6, this dielectric multilayer film has a reflection peak RPg having a center wavelength of 530 nm which is the same as the peak wavelength λpg of a green light, at which the reflectivity is 100%. The width Wrpg of the reflection peak RPg is determined by the refractive index difference between the high refractive index layer and low refractive index layer (in this case, difference between 1.66 and 1.455). Further, the sharpness of edges Erpg of the reflection peak RPg is determined by the number of repeats of the stacking unit (in this case, 27). Since the emission spectrum of each LED has a narrow half-band width as shown in FIG. 4, the dielectric multilayer film can reflect the most part of a green light that is emitted from the green LED in spite of its relatively narrow reflection peak shown in FIG. 6, if the center wavelength of the reflection peak correspond to the center wavelength of a green light.

Likewise, the same design principle is used to form the dielectric multilayer films for the blue LED having a peak wavelength λpb of 455 nm and red LED having a peak wavelength λpr of 640 nm. That is, the refractive index of the high refractive index layer set to nH=1.66 (CaCO₃) and refractive index of the low refractive index layer set to nL=1.455 (SiO₂). Dielectric multilayer film sets corresponding to a blue and red light emitted from the blue LED and red LED having spectrum characteristics shown in FIG. 4 and having peak wavelengths λpb of 455 nm and λpr of 640 nm are stacked respectively as a minimum unit at the rate represented by (0.5H1L0.5H) relative to the optical film thicknesses λpb/4 and λpr/4. Each of the obtained minimum unit is stacked 27 times.

A dielectric multilayer film consisting of total 163 layers including the high refractive index layers and low refractive index layers, in which respective dielectric multilayer film sets corresponding to red, green, and blue lights are all stacked, serve as the brightness enhancement film 33 that can polarize/split a light emitted from the LEDs having spectrum characteristics shown in FIG. 4 and reflect/reuse the polarization component, which has been unnecessary by being polarized/split.

In this case, wavelength-reflectivity characteristics of the polarization component having a polarization plane in the direction that the refractive index of CaCO₃, which is a dielectric material of the brightness enhancement film 33, is 1.66 becomes as shown in FIG. 7.

As shown in FIG. 7, the brightness enhancement film 33 has reflection peaks RPb having a center wavelength of 455 nm which is the same as the peak wavelength λpb of a blue light, RPg having a center wavelength of 530 nm which is the same as the peak wavelength λpg of a green light, and RPr having a center wavelength of 640 nm which is the same as the peak wavelength λpr of a red light, at which the reflectivity for each color is 100%. As a result, the brightness enhancement film 33 can almost perfectly reflect the polarization components of red, green, and blue lights, each having a polarization plane in the direction that the refractive index of CaCO₃ that forms the high refractive index layer is 1.66.

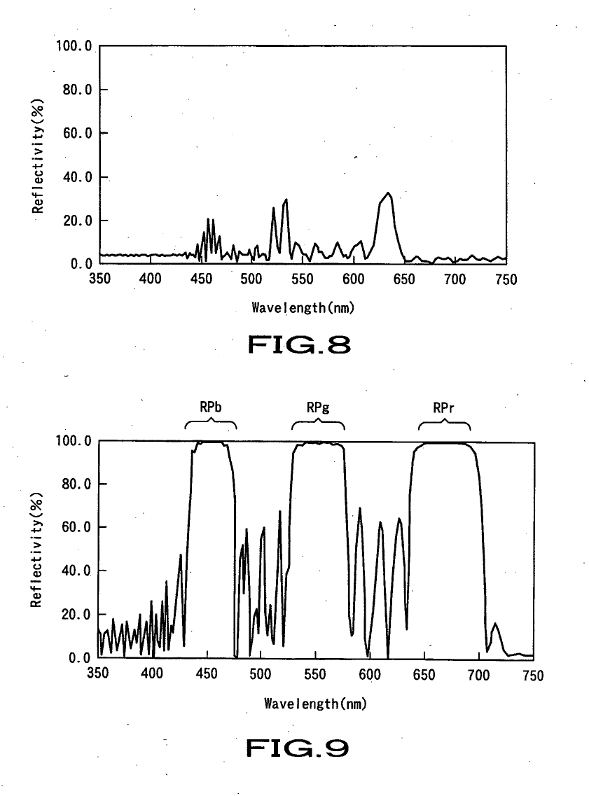

The refractive index difference between 1.455 which is the refractive index of the dielectric material SiO₂ that forms the low refractive index layer, and 1.48 which is the lower refractive index of the dielectric material CaCO₃ used as the high refractive index layer is very small. Therefore, the polarization component having a polarization plane in the direction that the refractive index of CaCO₃ forming the high refractive index layer of the brightness enhancement film 33 is 1.48 exhibits wavelength-reflectivity characteristics as shown in FIG. 8. It can be seen from FIG. 8, red, green, and blue lights are hardly reflected but entirely transmitted, although 20 to 30% of them are reflected at the vicinity of wavelengths of 455 nm, 530 nm, and 640 nm due to slight refractive index difference between 1.48 of CaCO₃ and 1.455 of SiO₂.

As described above, the brightness enhancement film 33 which is the dielectric multilayer film consisting of total 163 layers including the high refractive index layers and low refractive index layers can almost perfectly reflect the polarization components of red, green, and blue lights, each having a polarization plane in the direction of the higher refractive index difference, for example, S-polarized components, and can almost perfectly transmit the polarization components, each having a polarization plane in the direction of the lower refractive index difference, for example, P-polarized components.

When the above brightness enhancement film 33 is used for the color liquid crystal display apparatus 40 shown in FIG. 3, it is possible to polarize/split a white light emitted from the backlight unit 25 for respective color lights that constitute a white light as well as to reuse the reflected polarization components, thus preventing polarization components from being absorbed to become heat energy to suppress the loss. Accordingly, use efficiency of a light emitted from the backlight unit 25 and illuminating the color liquid crystal display panel 10 is increased to significantly enhance the brightness.

### EXAMPLE 2

### Film Design in Case Where Peak Wavelength of LED is Changed

In Example 2, the reflection characteristics of the brightness enhancement film 33 is examined in the case where respective peak wavelengths of the LEDs that the backlight unit 25 uses as a light source are shifted without changing the dielectric material used as the brightness enhancement film 33 which is the dielectric multilayer film.

The LEDs used as a light source are a blue LED having a peak wavelength λpb of 450 nm, a green LED having a peak wavelength λpg of 550 nm, and a red LED having a peak wavelength λpr of 670 min. The dielectric multilayer film corresponding to each color light is, as in the case of Example 1, obtained by stacking 27 times ((0.5H1L0.5H)²⁷) a minimum stacking unit in which the high refractive index layers and low refractive index layers are stacked at the rate represented by (0.5H1L0.5H) relative to each of the optical film thicknesses λpb/4, λpg/4, and λpr/4.

In the brightness enhancement film 33 which is the dielectric multilayer film consisting of total 163 layers including the high refractive index layers and low refractive index layers, in which respective dielectric multilayer films corresponding to red, green, and blue lights are all stacked, wavelength-reflectivity characteristics of the polarization component having a polarization plane in the direction that the refractive index of CaCO₃ that forms the high refractive index layer is 1.66 becomes as shown in FIG. 9.

As shown in FIG. 9, the reflection characteristics of the brightness enhancement film 33 has reflection peaks RPb having a center wavelength of 450 nm which is the same as the peak wavelength λpb of a blue light, RPg having a center wavelength of 550 nm which is the same as the peak wavelength λpg of a green light, and RPr having a center wavelength of 670 nm which is the same as the peak wavelength λpr of a red light, at which the reflectivity for each color is 100%.

That is, even when the respective peak wavelengths of the LEDs used as a light source are shifted, it is possible to almost perfectly reflect the respective polarization components of red, green, and blue lights, each having a polarization plane in the direction that the refractive index of CaCO₃ is 1.66 by changing the optical film thicknesses of the high refractive index layer and low refractive index layer in accordance with the peak wavelengths.

On the other hand, the respective polarization components, each having a polarization plane in the direction that the refractive index of CaCO₃ that forms the high refractive index layer of the brightness enhancement film 33 is 1.48 are, although not shown, hardly reflected but are transmitted as in the case of Example 1.

As a result, even when the respective peak wavelengths of the LEDs serving as a light source of the backlight unit 25 are shifted to desired values, by using the brightness enhancement film 33 in which the optical film thicknesses of the high refractive index layer and low refractive index layer are designed in accordance with the peak wavelengths, it is possible to polarize/split a white light emitted from the backlight unit 25 for respective color lights that constitute a white light as well as to reuse the reflected polarization components, thus preventing polarization components from being absorbed to become heat energy to suppress the loss. Accordingly, use efficiency of a light emitted from the backlight unit 25 and illuminating the color liquid crystal display panel 10 is increased to significantly enhance the brightness.

### EXAMPLE 3

### Film Design in Case Where Birefringence Material Other than CaCO₃ is Used

In Example 3, the reflection characteristics of the brightness enhancement film 33 is examined in the case where a dielectric material other than CaCO₃ is used as the dielectric material having birefringence characteristics used for the brightness enhancement film 33 which is the dielectric multilayer film. The LEDs to be used as a light source of the backlight unit 25 are, as in the case of Example 1, LEDs having the spectrum characteristics shown in FIG. 4.

(1) As the dielectric material having birefringence characteristics, Yittrium Vanadate (YVO₄) is used in place of CaCO₃ used in Examples 1 and 2. YVO₄ has different refractive indexes no=1.99 and ne=2.22 corresponding to different polarization planes of an incident light (λ=630 nm). Here, a description will be given about the polarization direction which is obtained by a combination of the refractive index nH=2.22 of the high refractive index layer and refractive index nL=1.455 of the low refractive index layer.

In this case, as represented by Δn=ne−no=0.765, refractive index difference is large. Therefore, a dielectric multilayer film is formed such that the center wavelength of reflection peak thereof is set to λgb=490 nm which is substantially the intermediate value between the peak wavelength λpg of a green light=530 nm and peak wavelength λpr of a blue light=455 nm. More specifically, a minimum stacking unit in which the high refractive index layer and low refractive index layer are stacked at the rate represented by (0.5H1L0.5H) relative to the optical film thicknesses λgb/4 is stacked 10 times ((0.5H1L0.5H)¹) to obtain a dielectric multilayer film.

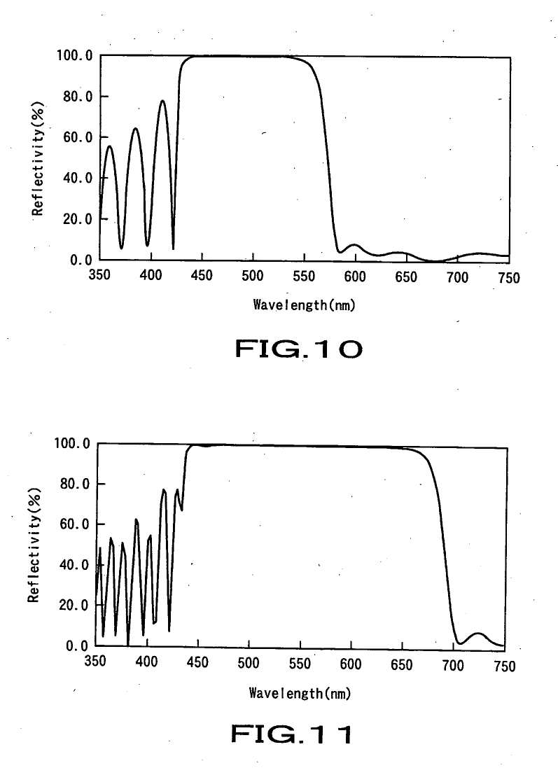

In the above dielectric multilayer film, wavelength-reflectivity characteristics of the polarization component having a polarization plane in the direction that the refractive index-of YVO₄ is 2.22 becomes as shown in FIG. 10. As can be seen from FIG. 10, when YVO₄ is used as the dielectric material having birefringence characteristics to form the dielectric multilayer film having the above configuration, it is possible to cover the emission spectrums of a blue light having a peak wavelength λpb of 455 nm and a green light having a peak wavelength λpg of 530 nm.

Therefore, in order to cover three primary color lights including a red light having a peak wavelength λpr of 640 nm, a dielectric multilayer film that polarizes/splits a red light is stacked on the above dielectric multilayer film, and thereby the brightness enhancement film 33 can be obtained. For example, the center wavelength of reflection peak thereof is set to λgr=590 nm which is substantially the intermediate value between the peak wavelength λpg of a green light=530 nm and peak wavelength λpr of a red light=640 nm.

More specifically, when a minimum stacking unit in which the high refractive index layer and low refractive index layer are stacked at the rate represented by (0.5H1L0.5H) relative to the optical film thicknesses λgr/4 is stacked 10 times ((0.5H1L0.5H)¹⁰) to obtain a dielectric multilayer film, the center wavelength of reflection peak thereof can be set to λgr=590 nm. The obtained dielectric multilayer film can polarize/split a green light having a peak wavelength λpg of 530 nm and a red light having a peak wavelength λpr of 640 nm.

That is, the brightness enhancement film 33 is a dielectric multilayer film consisting of total 41 layers including the high refractive index layers and low refractive index layers formed by stacking a dielectric multilayer film that polarizes/splits green and blue lights and a dielectric multilayer film that polarizes/splits green and red lights.

In this brightness enhancement film 33, wavelength-reflectivity characteristics of the polarization component having a polarization plane in the direction that the refractive index of YVO₄, that forms the high refractive index layer is 2.22 becomes as shown in FIG. 11. As shown in FIG. 11, the brightness enhancement film 33 has a reflection peak across the entire emission spectrum of the LEDs, at which the reflectivity is 100%. As a result, the brightness enhancement film 33 can almost perfectly reflect the polarization components of red, green, and blue lights, each having a polarization plane in the direction that the refractive index of YVO₄ that forms the high refractive index layer is 2.22.

On the other hand, the respective polarization components, each having a polarization plane in the direction that the refractive index of YVO₄ that forms the high refractive index layer of the brightness enhancement film 33 is 1.99, are, although not shown, hardly reflected but are transmitted as in the case of Example 1.

As a result, even when YVO₄ is used as the dielectric material used for the high refractive index layer of the brightness enhancement film 33 which is a dielectric multilayer film in place of CaCO₃, by adequately designing the high refractive index layer and low refractive index layer, it is possible to polarize/split a white light emitted from the backlight unit 25 for respective color lights that constitute a white light as well as to reuse the reflected polarization components, thus preventing polarization components from being absorbed to become heat energy to suppress the loss, as in the case of Examples 1 and 2. Accordingly, use efficiency of a light emitted from the backlight unit 25 and illuminating the color liquid crystal display panel 10 is increased to significantly enhance the brightness.

Further, the use of YVO₄ as the dielectric material that forms the high refractive index layer can significantly reduce the stacking number of high and low refractive index layers of the brightness enhancement film 33, as compared to the case of using CaCO₃. In this case, total stacking number can be reduced from 163 layers to 41 layers.

Further, the use of YVO₄ can realize 100% reflectivity across a wide rage of wavelengths as shown in FIG. 11, so that it is effective to increase the brightness in the case where CCFL having the spectrum characteristics as shown in FIG. 5 is used as a light source of the backlight unit 25.

(2) Barium Borate (α-BBO) is used as the dielectric material having birefringence characteristics in place of CaCO₃ used in Examples 1 and 2. α-BBO has different refractive indexes no=1.68 and ne=1.60 corresponding to different polarization planes of an incident light (λ=532 nm). Here, a description will be given about the polarization direction which is obtained by a combination of the refractive index nH=1.68 of the high refractive index layer and refractive index nL=1.455 of the low refractive index layer.

In this case, as represented by Δn=no−ne=0.225, refractive index difference is small. Therefore, as in the case of Example 1, a dielectric multilayer film-needs to be formed so as to correspond to peak wavelengths of the respective color lights emitted from the LEDs.

A dielectric multilayer film corresponding to a blue light having a peak wavelength λpb of 455 nm, dielectric multilayer film corresponding to a green light having a peak wavelength λpg of 530 nm, and dielectric multilayer film corresponding to a red light having a peak wavelength λpr of 640 nm are formed. The respective color lights are emitted from the blue LED, green LED, and red LED having the spectrum characteristics as shown in FIG. 4. More specifically, for each color light, a dielectric multilayer film of a minimum stacking unit is formed by stacking the high refractive index layers and low refractive index layers at the rate represented by (0.5H1L0.5H) relative to each of the optical film thicknesses λpb/4, λpg/4, and λpr/4. The obtained minimum stacking units-are stacked 27 times ((0.5H1L0.5H)²⁷) to obtain a dielectric multilayer film corresponding to respective color lights.

The dielectric multilayer film consisting of total 163 layers including the high refractive index layers and low refractive index layers, in which respective dielectric multilayer films corresponding to red, green, and blue lights are all stacked, serve as the brightness enhancement film 33 that can polarize/split a light emitted from the LEDs having spectrum characteristics shown in FIG. 4 and reflect/reuse the polarization component which was regarded as being unnecessary.

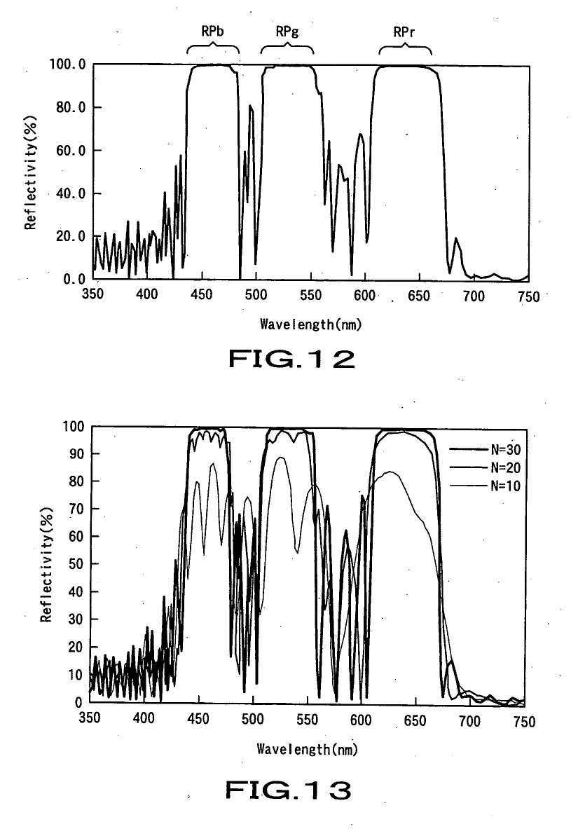

In this brightness enhancement film 33, wavelength-reflectivity characteristics of the polarization component having a polarization plane in the direction that the refractive index of α-BBO that forms the high refractive index layer is 1.68 becomes as shown in FIG. 12.

As shown in FIG. 12, the brightness enhancement film 33 has reflection peaks RPb having a center wavelength of 455 nm which is the same as the peak wavelength λpb of a blue light, RPg having a center wavelength of 530 nm which is the same as the peak wavelength λpg of a green light, and RPr having a center wavelength of 640 nm which is the same as the peak wavelength λpr of a red light, at which the reflectivity for each color is 100%. As a result, the brightness enhancement film 33 can almost perfectly reflect the polarization components of red, green, and blue lights, each having a polarization plane in the direction that the refractive index of α-BBO that forms the high refractive index layer is 1.68.

On the other hand, the respective polarization components of read, green, and blue lights, each having a polarization plane in the direction that the refractive index of α-BBO that forms the high refractive index layer of the brightness enhancement film 33 is 1.60, are, although not shown, hardly reflected but are transmitted as in the case of Example 1.

As a result, even when α-BBO is used as the dielectric material used for the high refractive index layer of the brightness enhancement film 33 which is a dielectric multilayer film in place of CaCO₃, by adequately designing the high refractive index layer and low refractive index layer, it is possible to polarize/split a white light emitted from the backlight unit 25 for respective color lights that constitute a white light as well as to reuse the reflected polarization components, thus preventing polarization components from being absorbed to become heat energy to suppress the loss, as in the case of Examples 1 and 2. Accordingly, use efficiency of a light emitted from the backlight unit 25 and illuminating the color liquid crystal display panel 10 is increased to significantly enhance the brightness.

### EXAMPLE 4

### In Case Where Stacking Number is Changed

In Example 1, the dielectric multilayer film corresponding to each color light is formed as follows. That is, a dielectric multilayer film corresponding to a blue light having a peak wavelength λpb of 455 nm, dielectric multilayer film corresponding to a green light having a peak wavelength λpg of 530 nm, and dielectric multilayer film corresponding to a red light having a peak wavelength λpr of 640 nm are formed. The respective color lights are emitted from the blue LED, green LED, and red LED having the spectrum characteristics as shown in FIG. 4. More specifically, for each color light, a dielectric multilayer film of a minimum stacking unit is formed by stacking the high refractive index layers and low refractive index layers at the rate represented by (0.5H1L0.5H) relative to each of the optical film thicknesses λpb/4, λpg/4, and λpr/4. The obtained minimum stacking units are stacked 27 times ((0.5H1L0.5H)²⁷) to obtain a dielectric multilayer film corresponding to respective color lights.

In Example 4, a relationship between the number of layers and reflectivity is examined in the case where the number of layers of a minimum stacking units, each represented by (0.5H1L0.5H), of the dielectric multilayer film corresponding to each color light is assumed to be N and N is changed to change the number of layers of the high and low refractive index layers included in the brightness enhancement film 33. In this example, CaCO₃ is used as the dielectric material having birefringence characteristics and the LEDs having spectrum characteristics shown in FIG. 4 are used as a light source of the backlight unit 25.

FIG. 13 shows wavelength-reflectivity characteristics of the polarization component having a polarization plane in the direction that the refractive index of CaCO₃ that forms the high refractive index layer is 1.66, wherein the number of layers of the minimum stacking units is set to 10, 20, and 30. As shown in FIG. 13, reflectivity 100% cannot be realized in the case of the number of layers N=10 and 20. When the number of layers N=30, reflectivity 100% can be achieved.

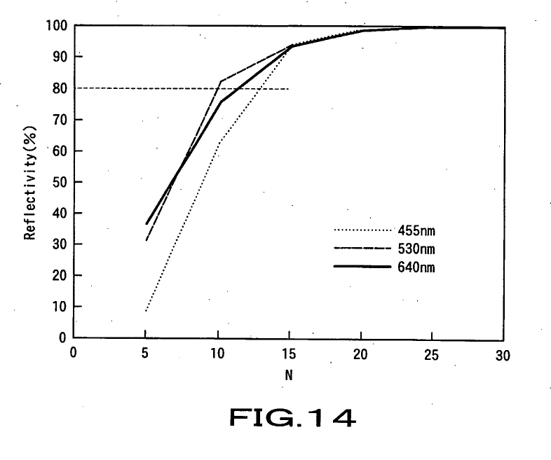

FIG. 14 shows a change in the reflectivity of the brightness enhancement film 33 in the case where the number of layers N of the minimum stacking units is gradually increased from 5, wherein the change in the reflectivity is plotted for respective peak wavelengths λpb=455 nm, λpg=530 nm, and λpr=640 nm of the LEDs used as a light source. It can be seen from FIG. 14, the reflectivity for each color of the brightness enhancement film 33 is linearly increased as the number of layers N is increased from 5 but enters a nonlinear saturation state at the time when it has exceeded reflectivity of about 80%.

As shown in FIGS. 13 and 14, the larger the number of layers N of the minimum stacking units of the dielectric multilayer film corresponding to each color light, the higher the reflectivity of the brightness enhancement film 33 becomes to exhibit favorable reflectivity characteristics. However, when the number of layers is excessively increased, the time and cost required for film formation are increased. Therefore, it is preferable to set the reflectivity of about 80% where the increase of the reflectivity enters a nonlinear saturation state as the lower limit of the number of layers N, and to determine the number of layers N of the minimum stacking units of the dielectric multilayer film corresponding to each color light so as to become larger than the lower limit within the design requirement for the color liquid crystal display apparatus 40.

That is, by setting the number of layers of the high and low refractive index layers that constitute the brightness enhancement film 33 such that the reflectivity of a light incident on the brightness enhancement film 33 becomes larger than 80%, it is possible to form the brightness enhancement film 33 capable of significantly increase the brightness of the color liquid crystal display apparatus 40 while suppressing a negative factor such as an increase in manufacturing time or manufacturing cost.

It should be understood by those skilled in the art that various modifications, combinations, sub-combinations and alternations may occur depending on design requirements and other factors insofar as they are within the scope of the appended claims or the equivalents thereof.

What is claimed is:

1. A reflecting polarizer that transmits a first linear polarization component that oscillates parallel to a first polarization plane of an incident light and reflects a second linear polarization component that oscillates parallel to a second polarization plane perpendicular to the first polarization plane by utilizing birefringence characteristics to polarize/split the incident light, comprising:
a dielectric multilayer film obtained by stacking, a plurality of times in an alternate manner,
a high refractive index layer formed using a dielectric material having birefringence characteristics; and
a low refractive index layer formed using a dielectric material having a refractive index which is substantially the same as one of the refractive indexes that the dielectric material having birefringence characteristics has.

2. The reflecting polarizer according to claim 1, wherein
the dielectric multilayer film is obtained by stacking
a first dielectric multilayer film that polarizes/splits a red light having a peak wavelength of λpr;
a second dielectric multilayer film that polarizes/splits a green light having a peak wavelength of λpg; and
a third dielectric multilayer film that polarizes/splits a blue light having a peak wavelength of λpb.

3. The reflecting polarizer according to claim 2, wherein
the first dielectric multilayer film is obtained by stacking a minimum stacking unit Nr (Nr is a natural number) times, the minimum stacking unit being a combination of a high refractive index layer having an optical film thickness of 0.5 times λpr/4, a low refractive index layer having an optical film thickness of λpr/4, and a high refractive index layer having an optical film thickness of 0.5 times the λpr/4,
the second dielectric multilayer film is obtained by stacking a minimum stacking unit Ng (Ng is a natural number) times, the minimum stacking unit being a combination of a high refractive index~layer having an optical film thickness of 0.5 times λpg/4, a low refractive index layer having an optical film thickness of λpg/4, and a high refractive index layer having an optical film thickness of 0.5 times the λpg/4, and
the third dielectric multilayer film is obtained by stacking a minimum stacking unit Nb (Nb is a natural number) times, the minimum stacking unit being a combination of a high refractive index layer having an optical film thickness of 0.5 times λpb/4, a low refractive index layer having an optical film thickness of λpb/4, and a high refractive index layer having an optical film thickness of 0.5 times the λpb/4.

4. The reflecting polarizer according to claim 3, wherein
the Nr is a value that makes the reflectivity for the second linear polarization component of the red light reflected by the first dielectric multilayer film larger than 80%,
the Ng is a value that makes the reflectivity for the second linear polarization component of the green light reflected by the second dielectric multilayer film larger than 80%, and
the Nb is a value that makes the reflectivity for the second linear polarization component of the blue light reflected by the third dielectric multilayer film larger than 80%.

5. The reflecting polarizer according to claim 1, wherein calcium carbonate (CaCO₃) is used as the dielectric material having birefringence characteristics.

6. The reflecting polarizer according to claim 1, wherein Barium Borate (α-BBO) is used as the dielectric material having birefringence characteristics.

7. The reflecting-polarizer according to claim 1, including, in a stacked manner,
a first dielectric multilayer film that polarizes/splits a green light having a peak wavelength of λpg and a blue light having a peak wavelength of λpb; and
a second dielectric multilayer film that polarizes/splits a green light having a peak wavelength of λpg and a red light having a peak wavelength of λpr.

8. The reflecting polarizer according to claim 7, wherein
assuming that the intermediate wavelength between the peak wavelength λpg of the green light and peak wavelength λpb of the blue light is λgb, the first dielectric multilayer film is obtained by stacking a minimum stacking unit Ngb (Ngb is a natural number) times, the minimum stacking unit being a combination of a high refractive index layer having an optical film thickness of 0.5 times λgb/4, a low refractive index layer having an optical film thickness of λgb/4, and a high refractive index layer having an optical film thickness of 0.5 times the λgb/4, and
assuming that the intermediate wavelength between the peak wavelength λpg of the green light and peak wavelength λpr of the red light is λgr, the second dielectric multilayer film is obtained by stacking a minimum stacking unit Ngr (Ngr is a natural number) times, the minimum stacking unit being a combination of a high refractive index layer having an optical film thickness of 0.5 times λgr/4, a low refractive index layer having an optical film thickness of λgr/4, and a high refractive index layer having an optical film thickness of 0.5 times the λgr/4.

9. The reflecting polarizer according to claim 8, wherein
the Ngb is a value that makes the reflectivity for the second linear polarization component of the green and blue lights reflected by the first dielectric multilayer film larger than 80%, and
the Ngr is a value that makes the reflectivity for the second linear polarization component of the green and red lights reflected by the second dielectric multilayer film larger than 80%.

10. The reflecting polarizer according to claim 1, wherein Yittrium Vanadate (YVO₄) is used as the dielectric material having birefringence characteristics.

11. A color liquid crystal display apparatus comprising:
a transmissive type color liquid crystal display panel having a color filter including three primary color filters that selectively transmit the wavelengths of a red light, a green light, and a blue light; a backlight unit that illuminates the color liquid crystal display panel from the backside thereof with a white light; and a reflecting polarizer between the color liquid crystal display panel and backlight unit,
the backlight unit having a light source constituted by a red LED that emits a red light having a peak wavelength of λpr, a green LED that emits a green light having a peak wavelength of λpg, and a blue LED that emits a blue light having a peak wavelength of λpb and color mixing means for mixing the red, green, and blue lights emitted from the light source to create the white color, and
the reflecting polarizer comprising a dielectric multilayer film obtained by stacking, a plurality of times in an alternate manner, a high refractive index layer formed using a dielectric material having birefringence characteristics; and a low refractive index layer formed using a dielectric material having a refractive index which is substantially the same as one of the refractive indexes that the dielectric material having birefringence characteristics has, and transmitting a first linear polarization component that oscillates parallel to a first polarization plane of a white light emitted from the backlight unit for respective red, green, and blue lights that constitute the white light and reflecting a second linear polarization component that oscillates parallel to a second polarization plane thereof that is perpendicular to the first polarization plane by utilizing birefringence characteristics to polarize/split the incident white light.

12. The color liquid crystal display apparatus according to claim 11, wherein
the dielectric multilayer film is obtained by stacking
a first dielectric multilayer film that polarizes/splits a red light having a peak wavelength of λpr;
a second dielectric multilayer film that polarizes/splits a green light having a peak wavelength of λpg; and
a third dielectric multilayer film that polarizes/splits a blue light having a peak wavelength of λpb.

13. The color liquid crystal display apparatus according to claim 12, wherein
the first dielectric multilayer film is obtained by stacking a minimum stacking unit Nr (Nr is a natural number) times, the minimum stacking unit being a combination of a high refractive index layer having an optical film thickness of 0.5 times λpr/4, a low refractive index layer having an optical film thickness of λpr/4, and a high refractive index layer having an optical film thickness of 0.5 times the λpr/4,
the second dielectric multilayer film is obtained by stacking a minimum stacking unit Ng (Ng is a natural number) times, the minimum stacking unit being a combination of a high refractive index layer having an optical film thickness of 0.5 times λpg/4, a low refractive index layer having an optical film thickness of λpg/4, and a high refractive index layer having an optical film thickness of 0.5 times the λpg/4, and
the third dielectric multilayer film is obtained by stacking a minimum stacking unit Nb (Nb is a natural number) times, the minimum stacking unit being a combination of a high refractive index layer having an optical film thickness of 0.5 times λpb/4, a low refractive index layer having an optical film thickness of λpb/4, and a high refractive index layer having an optical film thickness of 0.5 times the λpb/4.

14. The color liquid crystal display apparatus according to claim 13, wherein
the Nr is a value that makes the reflectivity for the second linear polarization component of the red light reflected by the first dielectric multilayer film larger than 80%,
the Ng is a value that makes the reflectivity for the second linear polarization component of the green light reflected by the second dielectric multilayer film larger than 80%, and
the Nb is a value that makes the reflectivity for the second linear polarization component of the blue light reflected by the third dielectric multilayer film larger than 80%.

15. The color liquid crystal display apparatus according to claim 11, wherein calcium carbonate (CaCO₃) is used as the dielectric material having birefrigence characteristics.

16. The color liquid crystal display apparatus according to claim 11, wherein Barium Borate (α-BBO) is used as the dielectric material having birefringence characteristics.

17. The color liquid crystal display apparatus according to claim 11, including, in a stacked manner,
a first dielectric multilayer film that polarizes/splits a green light having a peak wavelength of λpg and a blue light having a peak wavelength of λpb; and
a second dielectric multilayer film that polarizes/splits a green light having a peak wavelength of λpg and a red light having a peak wavelength of λpr.

18. The color liquid crystal display apparatus according to claim 17, wherein
assuming that the intermediate wavelength between the peak wavelength λpg of the green light and peak wavelength λpb of the blue light is λgb, the first dielectric multilayer film is obtained by stacking a minimum stacking unit Ngb (Ngb is a natural number) times, the minimum stacking unit being a combination of a high refractive index layer having an optical film thickness of 0.5 times λgb/4, a low, refractive index layer having an optical film thickness of λgb/4, and a high refractive index layer having an optical film thickness of 0.5 times the λgb/4, and
assuming that the intermediate wavelength between the peak wavelength λpg of the green light and peak wavelength λpr of the red light is λgr, the second dielectric multilayer film is obtained by stacking a minimum stacking unit Ngr (Ngr is a natural number) times, the minimum stacking unit being a combination of a high refractive index layer having an optical film thickness of 0.5 times λgr/4, a low refractive index layer having an optical film thickness of λgr/4, and a high refractive index layer having an optical film thickness of 0.5 times the λgr/4.

19. The color liquid crystal display apparatus according to claim 18, wherein
the Ngb is a value that makes the reflectivity for the second linear polarization component of the green and red lights reflected by the first dielectric multilayer film larger than 80%, and
the Ngr is a value that makes the reflectivity for the second linear polarization component of the green and red lights reflected by the second dielectric multilayer film larger than 80%.

20. The color liquid crystal display apparatus according to claim 11, wherein Yittrium Vanadate (YVO₄) is used as the dielectric material having birefringence characteristics.
